(19) United States
(12) Patent Application Publication
(10) Pub. No.: US 2005/0186307 A1
(43) Pub. Date: Aug. 25, 2005

(54) Pet food with enhanced nutritional value

(76) Inventor: Glen S. Axelrod, Colts Neck, NJ (US)

Correspondence Address: Grossman, Tucker, Perreault & Pfleger, PLLC, 55 South Commercial Street, Manchester, NH, 03101, US

(21) Appl. No.: 10/783,866

(22) Filed: Feb. 20, 2004

(51) Int. Cl. A23K 1/175

(52) U.S. Cl. 426/74

(57) ABSTRACT

The present invention comprises a nutritional additive system for pets comprising a separately packaged nutritional additive within a package of base pet food. The base pet food may be characterized as having been prepared at a temperature at or above 200° F. and/or a shear rate at or above 100 sec⁻¹. The nutritional additive may be stored in a container which is otherwise sealed from the environment, and which may be configured to dispense it contents, onto the base pet food, without substantial introduction of air and ensuing oxidation of its contents.

### FIELD OF THE INVENTION

This invention relates to a system and compositions for providing pet food products having improved nutritional value, and in particular, to a system for selectively providing vitamin/minerals or other food supplements in a pet food diet.

### BACKGROUND OF THE INVENTION

Not surprisingly, there have been a number of disclosures regarding the manufacture of pet food products. For example, in U.S. Pat. No. 4,020,187, entitled “Method of Producing Dry Pet Food” there is disclosed a method of producing a dry expanded pet food by extrusion cooking of a blended mixture of a proteinaceous material slurry and dry farniceous material. The proteinaceous material slurry is adjusted to have a fat content of at least 25%, is elevated to a temperature in the range of 150-175° F., and then homogenized to reduce particle size and distribute the fat content uniformly through the mixture. Farniaceous materials, constituting an appropriate dried ground mix of cereals, vitamins, minerals and preservatives are added to the proteinaceous slurry. Following the extrusion cooking step, which results in the expansion of the cooked material, the cooked material is dried to a water content of from 7% to 15%, resulting in what is described as a microbiologically stable, appetizing pet food.

U.S. Pat. No. 4,713,250, entitled “Dog Food Palatability Enhancer And Process” discloses a process for preparing a composition which improves the palatability of dog foods. According to the process, a staged enzyme reaction is employed to first digest either a proteinaceous or an amylaceous substrate. The reaction product of the first stage is then emulsified with fat, and the resulting emulsion is reacted with lipase and protease, under conditions which are said to be effective to provide a material which, when applied to a dog food, significantly improves its palatability.

U.S. Pat. No. 5,552,176 entitled “Pet Food Premix” discloses the formation of a premix comprising a mixture of about 40 to 70 wt % of non-rendered meat and the balance of at least one farinaceous and/or plant proteinaceous carrier substrate. The premix, when incorporated into an extruded pet food product, is said to increase its operational performance while delivering nutrients and palatability to the pet food product.

U.S. Pat. No. 5,894,029, entitled “Method Of Making Pet Snack Food” discloses a dried, puffed pet food comprised of farinaceous and proteinaceous materials and flavoring ingredients, trace minerals, vitamins and optionally medications, nutrients, and supplements as an inner puffed core matrix encapsulated within an outer shell composed of flavoring ingredients.

U.S. Pat. No. 6,270,820, entitled “Process For Dry Stable Intermediate Pet Food Composition”, discloses a process for making a dry, stable intermediate pet food including meat which includes the steps of combining a plurality of ingredients specified by a basal pet food formula, wherein the plurality of ingredients includes a slurry of meat. The plurality of ingredients are mixed to form the mixture, extruded and cut into flakes, and dried to a moisture content of less than about 10% by weight.

U.S. Pat. No. 6,350,485 entitled “Methods And Compositions For Enhancing Palatability Of Pet Food” discloses compositions and methods for enhancing the palatability of dry and semi-dry pet food compositions. In particular, extruded cat food compositions are disclosed. The palatability enhancer is said to include a dry cat food coating including tetrasodium pyrophosphate at about 0.1% to about 1.0% by weight of the finished pet food product. The palatability enhancer is applied after the extrusion process to the extruded particles or pieces of pet food.

U.S. Pat. No. 6,379,727 entitled “Flavoring System For Pet Foods” discloses the use of a multiplicity of individually packaged flavor additives, of different flavors, each said to be suitable for convenient topical application to a base pet food product. The system is said to provide the user with a choice of flavors to serve to a pet at an individual feeding and a convenient means to vary the flavor or diet of the pet.

Attention is also directed to the following U.S. patents, commonly owned by the assignee herein: U.S. Pat. No. 5,476,069 entitled “Molded Rawhide Chew Toy”; U.S. patent application Ser. No. 08/923,070 filed Sep. 3, 1997 entitled “Vegetable Based Dog Chew” now U.S. Pat. No. 6,093,427; U.S. patent application Ser. No. 08/738,423 filed Oct. 25, 1997 entitled “Edible Dog Chew” now U.S. Pat. No. 5,827,565; U.S. patent application Ser. No. 08/784,834 filed Jan. 17, 1997 entitled “Carrot-Based Dog Chew” now U.S. Pat. No. 5,941,197; U.S. patent application Ser. No. 09/114,872 filed Jul. 14, 1998 entitled “Heat Modifiable Edible Dog Chew” now U.S. Pat. No. 6,180,161; U.S. patent application Ser. No. 09/138,804 filed Aug. 21, 1998 entitled “Improved Edible Dog Chew” now U.S. Pat. No. 6,126,978; U.S. patent application Ser. No. 09/116,070 filed Jul. 15, 1998 entitled “Wheat & Casein Dow Chew With Modifiable Texture” now U.S. Pat. No. 6,110,521; U.S. patent application Ser. No. 09/116,555 filed Jul. 15, 1998 entitled “Heat Modifiable Peanut Dog Chew” now U.S. Pat. No. 6,093,441; U.S. patent application Ser. No. 09/227,767 filed Jan. 8, 1999 entitled “Method of Molding Edible Starch” now U.S. Pat. No. 6,159,516, U.S. application Ser. No. 09/793,799 filed Feb. 23, 2001, now U.S. Pat. No. 6,586,027. In addition to such patents, attention is also directed to the art cited in said patents and applications, as such art may provide background to the present invention.

Accordingly, although the prior art discloses various processes and compositions for enhancing the palatability of pet foods, it will be appreciated by those skilled in the art that a need continues to exist for improved methods and compositions which will allow both dry and semi-dry pet foods to deliver the vitamins, minerals and other nutritional additives that are typically degraded during the manufacture of, e.g., the extruded dry food pet products.

Along such lines it would be desirable therefore to provide consumers with a nutritional system for convenient use in pet foods, that will allow the consumer to continue to use dry and semi-dry pet food products, which products themselves are convenient to store and use, but which dry and semi-dry pet food products otherwise do not provide a full and fresh supplement of vitamins/minerals and other types of food additives that may be necessary and/or customized for any given animal.

### SUMMARY OF THE INVENTION

In one non-limiting embodiment, the present invention comprises a nutritional additive system for pets comprising a separately packaged nutritional additive and a package of base pet food containing said separately packaged nutritional additive.

In a further non-limiting embodiment the present invention comprises a nutritional additive system for pets comprising separately packaged nutritional additive, a package of base pet food containing said separately packaged nutritional additive, wherein said base pet food is characterized as having been prepared at a temperature at or above 200° F. and/or a shear rate at or above 100 sec⁻¹.

In a still further non-limiting embodiment, the present invention comprises a method for increasing the nutritional value of a pet food, said method comprising:
(a) forming a base pet food wherein said base pet food is formed by exposure to temperatures above 200° F. and/or a shear rate at or above 100 sec⁻¹;
(b) supplying packaging for said base pet food;
(c) supplying a nutritional additive for said base pet food wherein said nutritional additive is separately packaged;
(d) incorporating said separately packaged nutritional additive in said packaging for said base pet food and sealing said base pet food packaging containing said separately packaged nutritional additive.

### DETAILED DESCRIPTION OF PREFERRED EMBODIMENTS

The nutritional additive herein for restoring the vitamin, mineral or other useful component to the feeding process are preferably applied to dry and semi-dry pet foods, which in general have a moisture content of about 50% or less by weight, more commonly about 15-50% by weight. More preferably, dry or low-moisture content pet foods may include pet foods which contain less than 15% moisture, which are commonly prepared by extrusion type methods, inexpensively packaged in bulk form, and are highly convenient to store and use.

Unfortunately, one rather long-standing problem with the formation of dry or low-moisture content pet foods is that many are typically prepared by a manufacturing technique that involves heating and shearing, which can lead to degradation of, e.g., the vitamin components that may be placed in such products. Accordingly, while well-intentioned, the thermal history and shearing process may tend to reduce the nutritional effectiveness of certain nutritional additives that are incorporated in an extruded type pet food. Therefore the present invention preferably makes use of and is targeted for such pet foods as a base pet food for nutritional enhancement.

Indeed, in the broad context of the present invention, as set forth more fully below, the base pet food can be one that is prepared such that it is substantially devoid of nutritional additives such as vitamins and minerals, since such additives will be readily replaced prior to the feeding process. In that sense, the invention herein provides for the preparation of a base pet food that can be less expensive to produce, but which ultimately provides high nutritional value, including all essential vitamins, minerals and other types of nutritionally additives, that are sensitive to the processing conditions of typical base pet food preparations. Accordingly, in the context of the present invention, a base pet food can be supplied that contains less than about 1.0% by weight of any vitamins, minerals and/or herbs, and in a particularly preferred embodiment, less than 0.5% by weight of any vitamins, minerals and/or herbs, and in a most preferred embodiment, less than 0.1% by weight of any vitamins, minerals and/or herbs, including any percentages therebetween between 0.0-1.0% by weight.

In addition, another potential concerns for bulk packaged pet foods is that commonly, they remain open to the air for extended periods of time, and oxidation can lead to disruption of the original nutritional content, such as oxidation of certain vitamins or oxidation of certain minerals and trace elements. This then can restrict the original nutritional performance of the base food from realizing its original intended values.

Therefore, in the broad context of the present invention, the nutritional additives identified herein are suitable for use in any pet food product which, as a consequence of its manufacturing operation, is exposed to processing conditions (e.g., heat or shear profiles) which otherwise reduce the nutritional value of the vitamin or mineral components. Accordingly, the invention herein is applicable, e.g. to an extruded pet food, wherein the temperature in extrusion may exceed about 200° F., and which temperature results in degradation of the vitamin, mineral and/or herbal components of such base pet food composition. Additionally, the invention herein applies to pet food products that are exposed to such temperatures, in combination with shearing conditions, wherein the shear rates may be at or above about the shear rates that may be experienced in the extrusion process. Accordingly, the invention herein contemplates the use of a base pet food product which had been exposed to a shearing condition at or in excess of about 100 (sec)⁻¹ and more particularly, to a combined temperature at or above 200° F. in combination with a shear rate of at or above 100 (sec)⁻¹, including any and all values or ranges of temperatures and shear rates above such levels. For example, the present invention applies to any base pet food that may have been formed within the temperature range of between about 200-500° F. and at shear rates between the value of about 10²-10⁴ (sec)⁻¹.

Preferably, the pet food of the present invention contains one or more of those vitamins recommended for dogs by the American Association of Feed Control Officials (AAFCO). In the case of dogs, vitamins may comprise A, C, B₁₂, D, E, thiamine, riboflavin, panthothenic acid, niacin, pyridoxine, folic acid and choline. In the case of cats, the vitamins may comprise vitamins A, C, B₁₂, D, E, and K, thiamine, riboflavin, pyridoxine, niacin, panthothenic acid, folic acid, biotin and choline.

In addition, the pet food of the present invention also preferably comprises minerals. In the case of dogs, the preferred minerals are calcium, phosphorus, potassium, sodium, chloride, magnesium, iron, copper, manganese, zinc, iodine, selenium. However, it is to be noted that other trace minerals have been suggested, such as Co, Mo, Cd, As, Si, V, Ni, Pb and Sn. Furthermore, minerals such as potassium, calcium, phosphorous and magnesium are required in gram amounts/day, whereas iron, zinc, copper, iodine, and selenium are only required in mg or μg/day. The pet food herein can therefore be modified to reflect a higher or lower concentration of a given mineral, according to nutritional requirements.

Turning next to the herbal component, the herbs herein are preferably selected from the group consisting of St. Johns Wort, Kava Kava, Ginkgo Biloba, Ginseng (Asian or Siberian varieties), Echinacea and mixtures thereof. Other herbs include Catsclaw, Camomile, Golden Seal, Saw Palmetto, Valerina, V. Agnus-Castus, Black Cohosh, Bilberry and Milk Thistle. Herbs may also include aloe, astragalus, burdock, chaomile, chestnut, coriolus, versicolor, couchgrass, crampbark, dandelion root, dong quai, elecampane, evening primrose, eyebright, false unicorm root, feverfew, garlic ginger, goldenseal, gota kola, grape seed extract, green tea, guggulipid, hawthorn, hops, ivy, licorice, milk thistle, misteltoes (American Asian and European varieties), motherwort, oats, osha, passion flower, pumpkin pygeum, red clover, rosemary, sarsparilla, skullcap, saw plametto, stinging nettle, wild indigo, wild yam and yerba mansa. In addition, glucosamines and/or chondroiton can be added to any of the embodiments described herein.

Turning next to a consideration of the incorporation of the vitamins/minerals and/or herb additives of the present invention, it is preferable that such additives are separately packaged and incorporated on the bulk pet food, so that they are delivered in a non-degraded form to the animal at the time of the feeding process. In such regard, the present invention contemplates several methods and alternative type packaging to selectively locate such additives in the pet food product.

For example, such additives may be applied to the particles of dry or semi-dry pet food by spraying or dusting onto the particles or pieces of food. Preferably, the additives herein are packaged in a manner that makes them particularly suitable for home use, whereby the pet owner can conveniently and economically provide the nutritionally additives for a household pet. Accordingly, powdered or granular nutritional additives compositions are employed in the present invention and applied to the base pet food product, such as a dry palletized pet food, by sprinkling on the surface thereof.

Alternatively, the nutritional additives of the present invention may be supplied in a liquid medium, preferably an aqueous medium, and sprayed onto the base pet food, with a hand sprayer. Furthermore, in a particularly preferred embodiment as it relates to supplying the nutritional additives in a liquid medium, the packaging or container for the liquid medium can be one that allows for such liquid to be dispensed without introducing any make-up air, which would otherwise cause some unwanted oxidation of the nutritional additives.

For example, the container may comprise a flexible plastic type squeeze bottle, with an internal film membrane, and the nutritional additives may be placed in such container and within the film membrane under conditions which avoid exposure to oxygen. In addition, the container may comprise any type of suitable rigid material, including, e.g., rigid plastic, safety glass or metal material, thereby providing a rigid exoskeleton. Then, the act of dispensing of the liquid containing the nutritional additives is completed without any exposure to environmental air. In addition, the material of the container or the film membrane may be one that selectively shields the contents from the otherwise harmful effect of light radiation (UV), either through the use of UV absorbers or appropriate shielding pigmentation. Accordingly, in such particularly preferred embodiment, the nutritional additives tend to remain in their original and highly effective state, without oxidation, and without substantial light degradation, and the overall nutritional efficiency is sustained over the lifetime of the base pet food and at extremely high levels for any given pet.

More preferably, however, in the context of the present invention, the nutritional additives of the present invention are not only separately packaged, they are also conveniently contained within the packaging for the base pet food product. Furthermore, the nutritional additives while maintained in a separate container, also can make use of a container that provides automatic dosage control as may be necessary according to the needs of a particular animal. Therefore, the consumer can be certain that with each particular feeding, the proper and controlled amount of fresh nutritional additive is provided (vitamins/minerals and/or herbs) and there is no inadvertent overdosing with respect to the nutritional additives supplied.

Along such lines the dosage control feature of the present invention would, for example, take into consideration the effective concentration of the nutritional components as contained in a preferred aqueous based solution, and instruct the consumer that a certain amount of such liquid solution would be supplied for each spray onto the base pet food. Accordingly, for a particular animal, and for a particular quantity of food, a preferred number of sprays can be readily specified.

While the invention has been described in terms of various preferred embodiments, those skilled in the art will recognize that the invention can be practiced with modification and within the scope of the appended claims.

1. A nutritional additive system for pets comprising:
(a) separately packaged nutritional additive; and
(b) a package of base pet food containing said separately packaged nutritional additive.

2. The nutritional additive system of claim 1, wherein said separately packaged nutritional additive is packaged in an air-tight container which substantially prevents the introduction of air and which allows for dispensing of the nutritional additive without substantial introduction of air into said container.

3. The nutritional additive system of claim 1 wherein said container is a plastic container and said plastic contains UV absorbers to prevent UV exposure to said nutritional additive.

4. The nutritional additive system of claim 1 wherein said separately packaged nutritional additive includes an applicator for applying said nutritional additive to said base pet food.

5. The nutritional additive system of claim 4 wherein said separately packaged nutritional additive including said applicator further includes a dosage control device which regulates the amount of nutritional additive that may be applied to said base pet food.

6. The nutritional additive system of claim 1 wherein said separately packaged nutritional additive comprises a dry additive comprising one or more of a vitamin, and/or one or more of a mineral, and/or one or more of a herbal type additive.

7. The nutritional additive system of claim 1 wherein said separately packaged nutritional additive is in liquid form and comprises one or more of a vitamin, and/or one or more of a mineral, and/or one or more of a herbal type additive.

8. The nutritional additive system of claim 1 wherein said nutritional additive comprises vitamins selected from the group consisting of A, C, B₁₂, D, E, K, thiamine, riboflavin, panthothenic acid, niacin, biotin, pyridoxine, folic acid, choline and mixtures thereof.

9. The nutritional additive system of claim 1 wherein said nutritional additive comprises minerals selected from the group consisting of calcium, phosphorus, potassium, sodium, chloride, magnesium, iron, copper, manganese, zinc, iodine, selenium, cobalt, molybdenum, cadmium, arsenic, silicon, vanadium, nickel, lead, tin and mixtures thereof.

10. The nutritional system of claim 1 wherein said nutritional additive comprises herbs selected from the group consisting of St. Johns Wort, Kava Kava, Echinacea, Ginkgo Biloba, Ginseng, Catsclaw, Camomile, Golden Seal and mixtures thereof.

11. The nutritional system of claim 1 wherein said base pet food contains 0.0-1.0% (wt) of any vitamins, minerals and/or herbs.

12. The nutritional system of claim 11, wherein the concentration of said vitamins or minerals or herbs in said base pet food is below about 0.1% (wt).

13. A nutritional additive system for pets comprising:
(a) separately packaged nutritional additive
(b) a package of base pet food containing said separately packaged nutritional additive, wherein said base pet food is characterized as having been prepared at a temperature at or above 200° F. and/or a shear rate at or above 100 sec⁻¹.

14. The nutritional additive system for pets of claim 13, wherein said base pet food is characterized as having been prepared at a temperature range of between about 200-500° F. and at a shear rate of about 10²-10⁴ (sec)⁻¹.

15. A method for increasing the nutritional value of a pet food, said method comprising:
(a) forming a base pet food wherein said base pet food is formed by exposure to temperatures above 200° F. and/or a shear rate at or above 100 sec⁻¹;
(b) supplying packaging for said base pet food;
(c) supplying a nutritional additive for said base pet food wherein said nutritional additive is separately packaged; and
(d) incorporating said separately packaged nutritional additive in said packaging for said base pet food and sealing said base pet food packaging containing said separately packaged nutritional additive.

16 The method of claim 15 wherein said packaging for said nutritional additive comprises an air-tight container which container can dispense said nutritional additive without substantially exposing the additive in said container to air.

17. The method of claim 16 including the step of opening said sealed base pet food packaging and dispensing said nutritional additive on to said base pet food.
